(19) United States
(12) Patent Application Publication
(10) Pub. No.: US 2003/0210916 A1
(43) Pub. Date: Nov. 13, 2003

(54) High speed burst-mode opto-electronic receiver

(76) Inventors: Jean Gerardus Leonardus Jennen, Huizen (NL); Rob C. J. Smets, Weesp (NL)

Correspondence Address: Docket Administrator (Room 3J-219), Lucent Technologies Inc., 101 Crawfords Corner Road, Holmdel, NJ, 07733-3030, US

(21) Appl. No.: 10/424,701

(22) Filed: Apr. 28, 2003

(30) Foreign Application Priority Data
May 8, 2002 (EP) 022532222.0

(51) Int. Cl. H04B 10/06

(52) U.S. Cl. 398/202; 398/98

(57) ABSTRACT

A burst receiver is provided that receives an optical burst-mode signal including signals with different power levels and originating from different senders (e.g., transmitters). The burst receiver includes a converter arranged for receiving an input signal and providing an inverted and a non-inverted optical signal. The inverted and non-inverted optical signals are applied to a balanced receiver that provides an electrical output signal corresponding to the difference between the inverted and non-inverted optical signal.

### CROSS-REFERENCE TO RELATED APPLICATION

This application claims the benefit of priority from corresponding European Application Serial No. 02253222.0, filed May 8, 2002.

### TECHNICAL FIELD

The invention relates to a burst-mode receiver for receiving an optical burst-mode input signal.

### BACKGROUND OF THE INVENTION

Future optical communication links are likely to operate on burst-mode traffic, e.g. based on transfer of data packets. This means that no longer synchronous connections will be used between network nodes. These links will be replaced by a-synchronous connections, for instance by the use of Time Division Multiple Access (TDMA) techniques. The reason for this is that such a scheme fits the packet oriented network of the future.

The use of burst-mode techniques requires fast and accurate handling of the in-coming signals by the optical line termination and accurate handling of the optical power levels both on the transmitter and the receiver sides.

A problem that occurs when processing burst-mode signals is that signals originating from different optical network units may have different power-levels, as a consequence of different transmission levels, different distances between different optical network units and the optical line termination and the variation of temperature conditions. The difference between power levels of the burst signals makes it difficult for the high-speed burst-mode receiver to distinguish between a bit representing a ‘0’ and a bit representing a ‘1’, because the ‘0’-level of a first optical network unit can be close to the ‘1’-level of a second one.

A solution to this problem of varying amplitudes is disclosed by S. Brigati et al. in a paper entitled “A SiGe BiCMOS Burst-mode 155 Mb/s Receiver for PON”, (version downloaded from the following link via the Internet on Apr. 9, 2002:

http://www.eurotraining.net/ESSCIRC_{—}2001/esscirc_{—}2001/data/86.pdf.

In this paper the receiver of the burst-mode signals originating from different optical network units handles the varying amplitudes by applying different reference levels to the receiver circuitry, depending on which optical network unit the signals are received from. In ATM PON systems, each optical network unit can only transmit during a predetermined timeslot, so the receiver knows when to expect signals from each optical network unit and accordingly knows what reference level should be applied at which time. Also a reference level is applied that is indicative of the variance due to temperature conditions. With the aid of these reference signals, the receiver can correctly distinguish between a ‘0’ and a ‘1’-bit received from different optical network units.

This however, requires active elements in the burst receiver that constantly monitor the incoming data. Also, changes in the field, such as a new optical network unit, need to be accounted for in the optical line termination. The electronic circuits required to implement this method are very complex and expensive.

Another solution to the problem is disclosed in Decision Threshold Based on Dynamic Offset Compensation for Burst Mode Receiver, by T. den Bakker, Kun-Yii Tu and Y. K. Park: Proceedings of the ECOC 2001 in Amsterdam, The Netherlands, p. 123-124. The threshold value Vₜₕ, above which the signal is considered to represent a ‘1’-bit and below which the signal is considered to represent a ‘0’-bit, is constantly adjusted based on the value of the incoming signal. The threshold value equals: Vₜₕ=V_{sig}/2, where V_{sig} is the peak value of the incoming signal. Also an offset is added to the Vₜₕ if V_{sig} is zero, in order to prevent chattering. However, this technique requires active electronic components in the optical line termination and constant monitoring of the incoming signal.

### SUMMARY OF THE INVENTION

According to the principles of the invention, a burst-mode receiver is provided that is capable of receiving burst-mode packets having uncertain power levels without requiring complex and expensive electronic circuits.

According to one illustrative embodiment, a burst receiver includes a conversion means arranged for receiving the input signal and providing an inverted and a non-inverted optical signal, and a balanced receiver arranged for receiving the inverted and non-inverted optical signal and providing an electrical output signal corresponding to the difference between the inverted and non-inverted optical signal. Such a burst receiver is capable of supporting all digital data streams, regardless of the power level. Also, such a burst receiver is capable of high-speed reception, e.g., up to and beyond 10 Gb/s.

In a further embodiment, the conversion means is arranged to provide an inverted and a non-inverted optical signal having a predetermined DC-power level. The predetermined DC-power level may be 0V, which allows for use of very simple detection logic for discriminating ‘0’ and ‘1’ bit levels. Consequently, a receiver according to the principles of the invention is independent of the average received optical power.

In another illustrative embodiment, the conversion means may be arranged to provide an inverted and a non-inverted optical signal of which the respective ‘1’ and ‘0’-power levels are equal to enable optimum receiver performance.

In yet another illustrative embodiment, the conversion means may comprise at least one wavelength conversion element for receiving an optical continuous wave signal at a first wavelength and the input signal at a second wavelength and for outputting an inverted and/or non-inverted optical signal at the first wavelength. In case the burst receiver is also used as a transmitter, the optical continuous wave signal can, for example, be the continuous wave signal used for transmission. The wavelength thereof may even be the same as the received wavelength when a counter propagating continuous wave signal with respect to the received signals is used.

In one illustrative embodiment, the balanced receiver may comprise two photodiodes connected in series for receiving the inverted and non-inverted optical signal, respectively, to allow for a reduced complexity and cost-effective implementation.

In another illustrative embodiment, the wavelength conversion element may comprise a combination of semiconductor optical amplifiers and an optical coupler, which allows for a cost-effective implementation using off-the-shelf optical components and also which allows for integration into a single chip/module for further cost efficiencies. This embodiment also has the benefit of improved noise properties because the amplified stimulated emission of a semiconductor optical amplifier-based Mach-Zehnder interferometer is at least partly cancelled out by the balanced receiver. Additional known signal-regenerating properties of a Mach-Zehnder structure will also improve overall receiver performance.

Elements of the burst-mode receiver may be integrated in a single device according to the principles of the invention, thus enabling a compact solution. According to another aspect, the optical and electronic elements of the burst-mode receiver may be integrated in a single device for further compactness.

### BRIEF DESCRIPTION OF THE DRAWING

A more complete understanding of the invention may be obtained from consideration of the following detailed description of the invention in conjunction with the drawing, with like elements referenced with like reference numerals, in which:

FIGS. 1a-d show graphs of a signal in different phases of processing according to the principles of the invention;

FIG. 2 shows a schematic diagram of an illustrative embodiment of the invention;

FIG. 3 shows a schematic diagram of an illustrative embodiment of a balanced optical receiver according to the principles of the invention; and

FIG. 4 shows a schematic diagram of an illustrative embodiment of a wavelength conversion element according to the principles of the invention.

### DETAILED DESCRIPTION

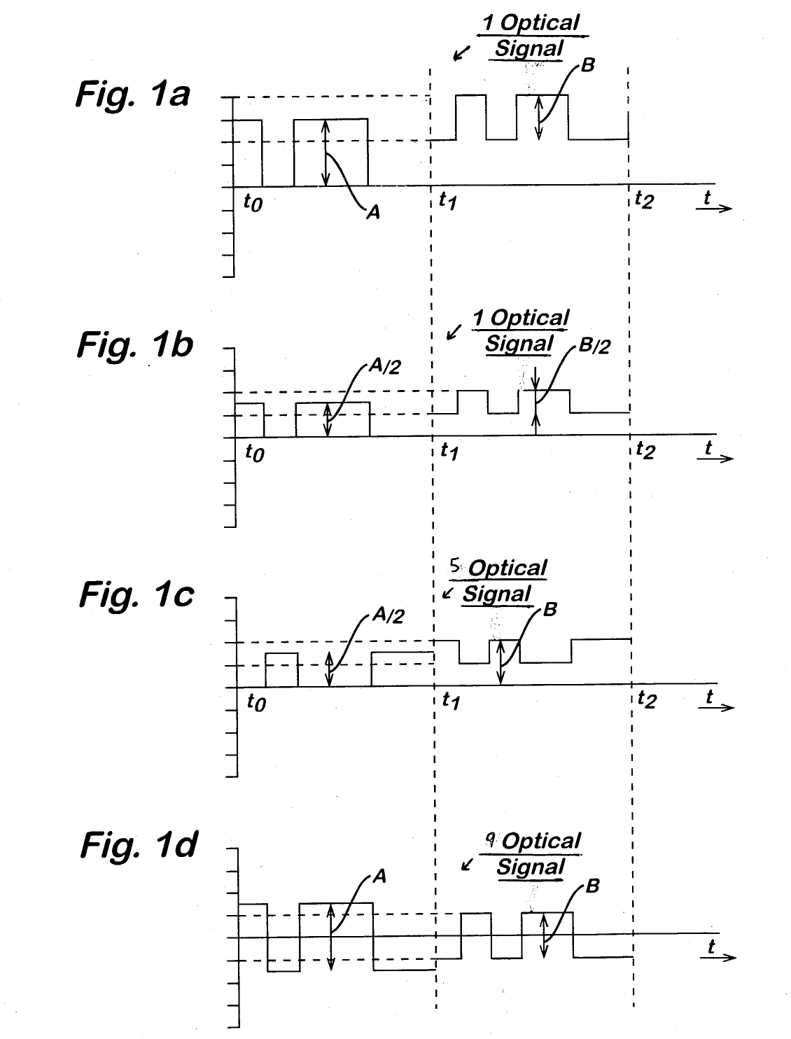

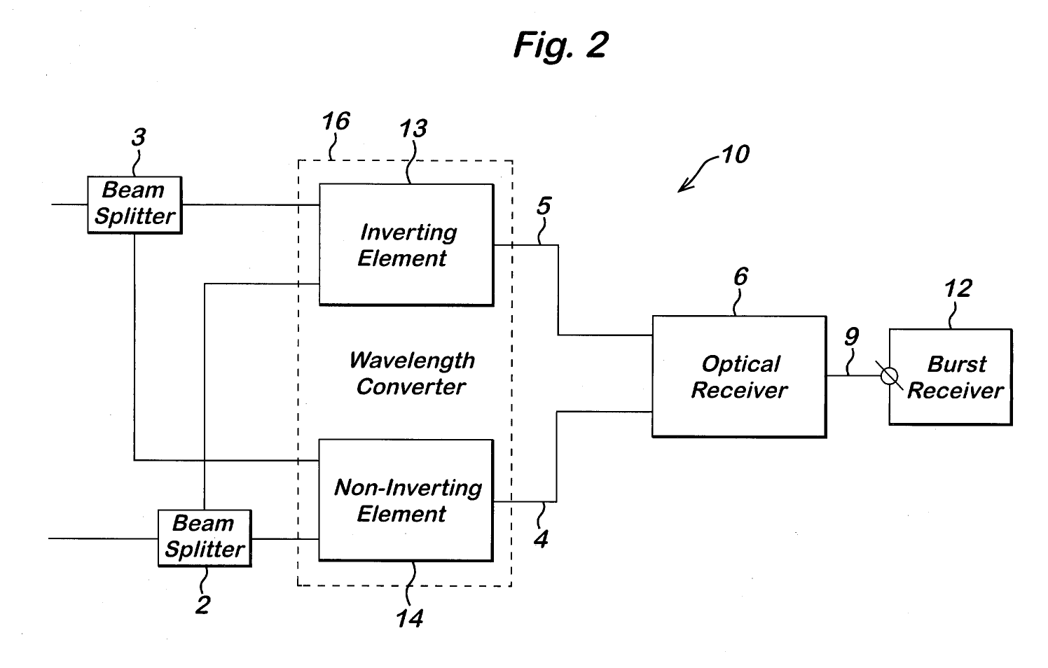

FIG. 1a shows a graph of a possible optical signal 1 that is received by an optical receiver 10 (shown in FIG. 2) in an optical communication network. Optical signal 1 is, for example, an optical burst-mode signal, received from different transmitters using a time division multiplex access (TDMA) technique to allow sharing of a single optical communication channel.

Optical signal 1 in FIG. 1a comprises two successive signals: a signal A from a first transmitter and a signal B from a second transmitter, occupying timeslots t₀-t₁ and t₁-t₂ respectively. Both signals A and signal B represent a digital signal comprising “0” and “1” bits.

However, signal B has different amplitudes and also has a different DC-component than signal A. The fact that the “0” value of signal B is close to the “1” value of signal A will cause problems to a receiver trying to distinguish between a “0” and a “1” bit. The uncertain optical power levels for the “0” and the “1” bit signals may e.g. originate from different distances between the first transmitter and the receiver and the second transmitter and the receiver, and/or from different optical losses in the respective communications paths.

FIG. 2 shows a first exemplary embodiment of the invention. The optical signal to be received and processed in the optical receiver 10 (e.g., optical signal 1 from FIG. 1a) is input to a first beam splitter 2 to obtain two equal signals at half the optical power. Signal 1 has a wavelength λ₀, so accordingly, both the equal signals at half the power have the same wavelength λ₀. FIG. 1b shows such a signal at half the optical power.

The two signals are input to an inverting element 13 and a non-inverting element 14 to obtain an inverted signal 5 and a non-inverted optical signal 4, respectively. In this case, the non-inverting element 14 does not change the received signal. The inverted signal 5, however, is inverse to signal 4, but has the same DC-component as the non-inverted signal 4. An example of the inverted signal 5 is depicted in FIG. 1c. The inversion can best be understood by comparing FIG. 1c with FIG. 1b.

These signals 4, 5 are then input to a balanced optical receiver 6. Balanced optical receiver 6 effectively provides an electrical signal 9 at its output, which is centered around a preset voltage, e.g. 0V, as is shown in FIG. 1d.

The electrical signal 9 is then input to a burst receiver 12, which is arranged to sample the electrical signal 9 with a threshold level of e.g. 0V, allowing easy detection of the “0” and “1” levels of the input optical signal 1.

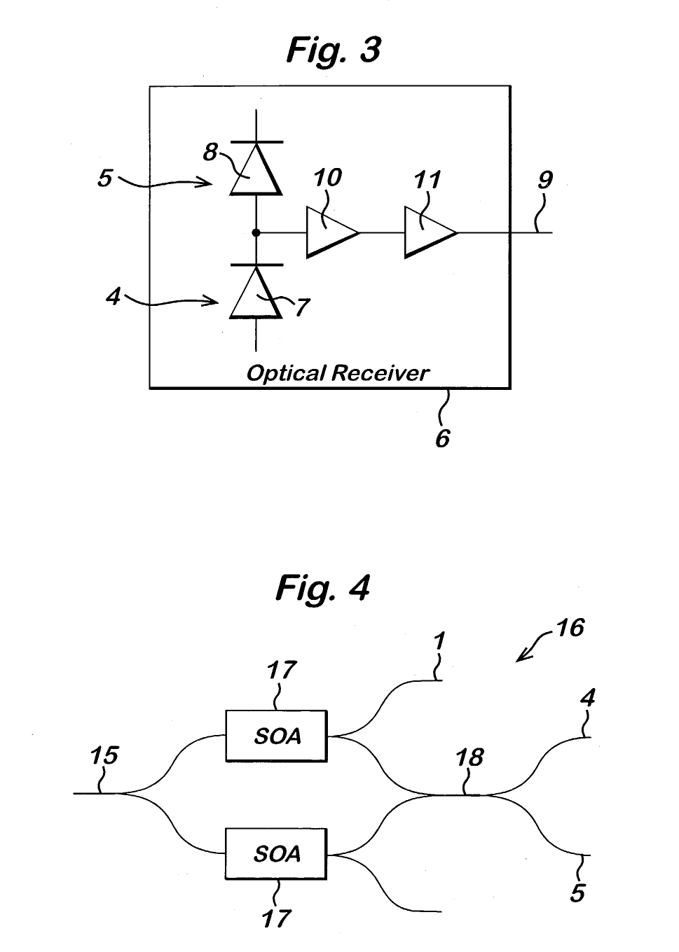

An example of such a balanced optical receiver 6, as depicted in FIG. 3, comprises two photodiodes 7, 8, connected in series, with the cathode of the lower photo-diode 7 connected to the anode of the upper photodiode 8, where signal 4 is applied to the first photodiode 7 of the balanced receiver 6 and signal 5 is applied to the second photodiode 8 of the balanced receiver 6. Such photodiodes 7, 8 are known to a person skilled in the art and induce a current that, among other parameters, depends on the amount of light that impinges on the photodiodes 7, 8.

An electrical signal 9 taken from the connection between the first and the second photodiodes 7, 8 corresponds to the difference between signal 4 and signal 5. The signal 9 is centered around zero, and has accordingly a DC-component of zero.

The electrical signal 9 can be further applied to a transimpedance amplifier 10 and a limiting amplifier 11. Limiting amplifier does not see a DC-component. Signal 9 can then be further applied to a processing unit (e.g., burst receiver 12), where sampling and synchronization can be done to further process signal 9. Of course, all kinds of processing units can be used here, known to a person skilled in the art, to allow interfacing with signal processing electronics, such as a demultiplexer, e.g., for SDH/SONET applications. Conventional AC-coupled limiting amplifiers can be used to limit the signal levels to allow easy and robust interfacing with signal processing electronics.

As can be seen in FIG. 1d, the signal 9 is centered around zero. Because the DC-component of signal 9 equals zero, the burst receiver 12 can easily distinguish between parts of the signal 9 representing a 1-bit and parts of the signal representing a 0-bit, because the same threshold (namely zero) can be used for signal A and signal B.

Best results are obtained if the amplitude levels of the signals are equal to the amplitude level of the signal 5. This means that the high “1” and low values “0” of the signals are equal to the high “1” and low “0” values of signal 5.

An effective way to implement the inverting element 13 and non-inverting element 14 in the optical domain is by using wavelength converters, which as such are known to the person skilled in the art. In this embodiment, a continuous wave signal is also required, which has a wavelength of λₓ (see FIG. 2). This signal is split in a first and a second part by an optical splitter 3. One of the two equal input signals (from splitter 2) is applied to a non-inverting wavelength converter 14 together with the first part of the continuous wave signal (from splitter 3). Wavelength converter 14 converts the input signal into a signal 4 having a carrier wavelength λₓ and a predetermined DC-component.

The other input signal (from splitter 2) is applied to an inverting wavelength converter 13 together with the second part of the continuous wave signal (from splitter 3). The inverting wavelength converter 13 outputs a signal 5, where signal 5 has a carrier wavelength λₓ, and is inverse to signal 4, but has the same DC-component. When signal 4 is high compared to the DC-component, signal 5 is low compared to the DC-component.

According to a different embodiment, the inverting wavelength converter 13 and the non-inverting converter 14 can both be integrated in one single wavelength converter 16. The input signal (e.g., signal 1 that was shown to enter splitter 2) and the continuous wave signal (that was shown to enter splitter 3) are both applied to the single wavelength converter 16. This allows a compact solution.

According to yet another embodiment, the inverting wavelength converter 13, the non-inverting wavelength converter 14, and the first and second beam splitter 2, 3 can be integrated in one single device, so even a more compact solution is provided.

According to yet another aspect of the invention, the arrangement is not only used for receiving signals, but also for transmitting signals, e.g., the transmitter wavelength signal can be used as the continuous wave signal, which has a wavelength of λₓ. In that case, no additional laser is needed. The wavelength might even be the same as the received wavelength λ₀ when a counter propagating continuous wave signal with respect to signals from splitter 2 and 3 are used.

FIG. 4 shows a schematic diagram of one exemplary implementation of the wavelength conversion element used in the present invention, using a Mach Zehnder interferometer based on the use of semiconductor optical amplifiers (SOA-based Mach Zehnder-interferometer 16). The SOA-based Mach Zehnder-interferometer 16 comprises a 2×2 coupler 18, which is connected to output ports of two semiconductor optical amplifiers (SOAs) 17. The use of a 2×2 coupler 18 and SOAs 17 is known to a person skilled in the art. Continuous wave signal 15, which has a wavelength of λₓ, is applied to an input port of both SOAs 17. Splitting of signal 15 can be done using a 1×2 coupler, as is shown in FIG. 4, or can be done using a 2×2 coupler (not shown), where signal 15 is applied to one input. Both types of couplers are known to a person skilled in the art.

In this exemplary embodiment, burst-mode (input) signal 1 is applied to a second input port of the first SOA 17 only, while it is not supplied to the second SOA 17. The output signals of both the SOAs 17 are applied to the 2×2 coupler 18. As a result, the non-inverted signal 4 appears on one output port of the 2×2 coupler 18 and the inverted signal 5 appears on the other output port of the 2×2 coupler 18, as will readily be understood by a person skilled in the art. This embodiment provides improved noise properties because the amplified stimulated emission of the SOA-based Mach Zehnder-interferometer is at least partly cancelled by the balanced receiver.

This embodiment has the potential of being integrated with the balanced receiver 6 and an electrical demultiplexer on a single chip or single package/module, using known semi-conductor production techniques.

The present invention can also be used in high-speed optical networks that, for example, use burst-mode techniques. Processing speeds beyond the 10 Gb/s range are contemplated by the teachings of the invention because the conversion of the signal is done in the optical domain instead of the electrical domain.

For the purpose of teaching the invention, preferred embodiments of the method and devices of the invention were described. However, it will be apparent to the person skilled in the art that other alternative embodiments of the invention can be conceived and reduced to practice without departing from the true spirit of the invention, the scope of the invention being only limited by the claims appended hereto.

What is claimed is:

1. A burst-mode receiver comprising:
conversion means arranged for receiving an optical burst-mode input signal and for providing an inverted and a non-inverted optical signal thereof, and
a balanced receiver adapted to receive the inverted and non-inverted optical signals and provide an electrical output signal that corresponds to the difference between the inverted and non-inverted optical signal.

2. The burst-mode receiver according to claim 1, wherein the inverted and non-inverted optical signals have a predetermined DC-power level.

3. The burst-mode receiver according to claim 2, wherein the conversion means is adapted to provide the inverted and a non-inverted optical signals such that respective “1” and “0” bit power levels are equal.

4. The burst-mode receiver according to claim 1, wherein the conversion means comprises at least one wavelength conversion element for receiving an optical continuous wave signal at a first wavelength and the optical burst-mode input signal at a second wavelength and for outputting an inverted and/or non-inverted optical signal at the first wavelength.

5. The burst-mode receiver according to claim 4, wherein the wavelength conversion element comprises:
a first semiconductor optical amplifier for receiving the optical continuous wave signal at a first input port and the burst-mode input signal at a second input port;
a second semiconductor optical amplifier for receiving the optical continuous wave signal at a first input port; and
an optical coupler, connected to an output port of both the first and second semiconductor optical amplifiers, for providing the inverted and non-inverted optical signals at respective output ports.

6. The burst-mode receiver according to claim 1, wherein the balanced receiver comprises two photodiodes connected in series for receiving the inverted and non-inverted optical signals, respectively.

7. The burst-mode receiver according to claim 1, wherein the conversion means and the balanced receiver are integrated in a single device.

8. An apparatus comprising:
a wavelength convertor adapted for receiving an optical burst-mode input signal and for providing an inverted and a non-inverted optical signal thereof, and
a balanced receiver adapted to receive the inverted and non-inverted optical signals and provide an electrical output signal that corresponds to the difference between the inverted and non-inverted optical signal.

9. The apparatus according to claim 8, wherein the inverted and non-inverted optical signals have a predetermined DC-power level.

10. The apparatus according to claim 9, wherein the wavelength convertor is adapted to provide the inverted and a non-inverted optical signals such that respective “1” and “0” bit power levels are equal.

11. The apparatus according to claim 10, wherein the wavelength convertor is adapted to receive an optical continuous wave signal at a first wavelength and the optical burst-mode input signal at a second wavelength and is further adapted to output an inverted and/or non-inverted optical signal at the first wavelength.

12. A method of processing an optical burst-mode input signal comprising:
converting the optical burst-mode input signal to provide an inverted and a non-inverted optical signal thereof, and
in a balanced receiver, providing an electrical output signal that corresponds to the difference between the inverted and non-inverted optical signal.

13. The method according to claim 12, wherein the inverted and non-inverted optical signals have a predetermined DC-power level.

14. The method according to claim 13, further comprising the step of providing the inverted and a non-inverted optical signals such that respective “1” and “0” bit power levels are equal.

15. The method according to claim 12, wherein the step of converting comprises:
receiving an optical continuous wave signal at a first wavelength and the optical burst-mode input signal at a second wavelength; and
outputting an inverted and/or non-inverted optical signal at the first wavelength.
